(19) United States
(12) Patent Application Publication
(10) Pub. No.: US 2013/0014626 A1
(43) Pub. Date: Jan. 17, 2013

(54) Knife Guide And Finger Protection Device

(71) Applicant: Scott Paul Jones, Grand Island, FL (US)

(72) Inventor: Scott Paul Jones, Grand Island, FL (US)

(21) Appl. No.: 13/182,699

(22) Filed: Jul. 14, 2011

(51) Int. Cl. B26B 29/06

(52) U.S. Cl. 83/821

(57) ABSTRACT

Apparatus including a first U shaped member having two vertical arms and a cross member located at the bottom ends of the two arms, two rails each having a top end attached to the top end of the first U shaped member and a bottom end where the two rails are located behind the two vertical arms of the first U shaped member, and a second inverted U shaped member having two vertical arms and a cross member which is attached to the top ends of the two arms where the two vertical arms are located behind and attached to the bottom ends of the two rails. The space between the two vertical arms of the first U shaped member and the two rails located behind the two vertical arms of the first U shaped member form two spaced apart slots for guiding a knife blade as it is moved up and down while cutting or chopping a food item.

### BACKGROUND OF THE INVENTION

1. Field of the Invention

The present invention relates generally to a knife guide and finger attachment which provides a safe and expedient apparatus and method of cutting and chopping produce and other items by hand with a cutting implement such as a knife and, more specifically, to a training tool which includes a finger protective fixture which gives a user the ability to cut and chop in an expedient manner without fear of injury caused by cutting or slicing the user's hand or finger of the hand which is holding the work piece.

2. Description of Related Art

Apparatus for guiding a knife blade while cutting food is known in the prior art. More specifically, by way of example, U.S. Pat. No. 5,974,671 to Dunn discloses a cutting guide attachment for an electric knife including a plastic housing having an inboard portion for attaching the handle to an electric knife. It also includes an outboard portion operatively positioned to the reciprocating blades of the electric knife. The housing has U-shaped fingers ascending downwardly from the end of the outboard portion of the housing and second inverted U-shaped fingers extending downwardly from an intermediate region of the outboard portion of the housing.

U.S. Pat. No. 5,724,877 to Kensrue discloses a tool is used to hold a food product upright while a user manually cuts the food product by slicing the food product from edge to edge with a blade of a knife. The tool includes a base having a top surface adapted to support the food product, a pair of knife blade guide members attached to the base opposite each other and spaced apart to provide a cutting zone, and a cutting pad in the cutting zone.

U.S. Pat. No. 5,577,430 to Gunderson, et al. discloses a device for cutting a food into slices. The device includes an indexing assembly having a rotatable indexing disc which may be moved to various positions corresponding to a desired thickness of the slice and having an indexing pin which, when seated in a predetermined notch, prevents rotation of the indexing disc against which the food product is abutted.

U.S. Pat. No. 5,575,070 to Anderson discloses a cutting implement with an adjustable guide, such as a knife, a guide adjustable with respect to the blade, and a knob substantially received in a cavity formed in the upper region of the knife handle. The knob protrudes from the cavity and cooperates with the guide so that a user can adjust the space between the guide and the blade by rotation of the knob.

U.S. Pat. No. 5,697,276 to Nassau discloses a food slicing device that holds food, particularly bread, in place while slicing. The bottom of the bread loaf is pierced to hold the loaf in place while slicing. Adjustment plates provide for varying slice width, or duplicating a slice of standard thickness.

U.S. Pat. No. 4,771,664 to Holz discloses an apparatus for cutting bacon and sausage. The apparatus includes a carrying body from which holding flanges extend forwardly. Front and rear guide frames are supported in the holding flanges. Lattice knives move perpendicularly to one another and to the feed direction of the material to be cut.

U.S. Pat. No. 4,447,051 to Price discloses a chopping-cutting board where chopped foods are contained during and after processing by two lateral side barriers, one of which has a cutaway opening on the rear, to provide a passage for long food objects to be delivered for cutting while providing a full length opposite vertical side barrier for containing foods being processed on the cutting surface. The general triangular shape of the board relates to the arc described by a french chopping knife. As the tip of a knife is held as a pivot, the handle end of the board describes this arc as it follows the movement described by the knife creating the shape relating to the board.

### SUMMARY OF THE INVENTION

In an exemplary embodiment of the present invention, there is disclosed apparatus for guiding a knife blade as it moves up and down while cutting or chopping a food item comprising:

a first U shaped member having two vertical arms and a cross member which is located at and is attached to the bottom ends of the two arms;

two rails each having a top end attached to the top end of the first U shaped member and a bottom end wherein the two rails are located behind the two vertical arms of the first U shaped member; and

a second inverted U shaped member having two vertical arms and a cross member which is located at and is attached to the top ends of the two arms wherein the two vertical arms are located behind and attached to the bottom ends of the two rails;

wherein the space between the two vertical arms of the first U shaped member and the two rails located behind the two vertical arms of the first U shaped member form two spaced apart slots for guiding a knife blade as it is moved up and down while cutting or chopping a food item.

In another exemplary embodiment of the present invention, there is disclosed a method for guiding a knife blade as it moves up and down while cutting or chopping a food item comprises:

providing a first U shaped member having two vertical arms and a cross member which is located at and is attached to the bottom ends of the two arms;

providing two rails each having a top end attached to the top end of the first U shaped member and a bottom end wherein the two rails are located behind the two vertical arms of the first U shaped member; and

providing a second inverted U shaped member having two vertical arms and a cross member which is located at and is attached to the top ends of the two arms wherein the two vertical arms are located behind and attached to the bottom ends of the two rails;

wherein the space between the two vertical arms of the first U shaped member and the two rails located behind the two vertical arms of the first U shaped member form two spaced apart slots for guiding a knife blade as it is moved up and down while cutting or chopping a food item.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of a knife guide and finger protection device in accordance with the principles of the invention;

FIG. 2 is a perspective view of the knife guide and finger protection device of FIG. 1 with finger attachment;

FIG. 3 is a perspective view of the knife guide and finger protection device of FIG. 1 with finger attachment attached to users two fingers;

FIG. 4 is another perspective view of the knife guide and finger protection device of FIG. 1 with finger attachment attached to users two fingers;

FIG. 5 is a perspective view of the knife guide and finger protection device of FIG. 1 with knife and work piece;

FIG. 6 is a perspective view of the knife guide and finger protection device of FIG. 5 with knife and finger attachment attached to users two fingers absent the work piece;

FIG. 7 is a perspective view of the finger protection device;

FIG. 8 is a cross sectional view of the finger protection device of FIG. 7; and

FIG. 9 is a side perspective view of the finger protection device of FIG. 7.

### DESCRIPTION OF THE PREFERRED EMBODIMENT

The present invention relates generally to a knife guide and finger attachment which provides a safe and expedient apparatus and method of cutting and chopping produce and other food items by hand with a cutting implement such as a knife and, more specifically, to a training tool which includes a finger protective fixture which gives a user the ability to cut and chop in an expedient manner without fear of injury caused by cutting or slicing the user's hand or finger of the hand which is holding the work piece

Referring to FIGS. 1 through 9 which show various views of the invention, the knife guide and finger protection device is attached to the index and/or middle finger of the user's hand which will hold and guide a work piece such as vegetables, herbs, meat products or other items routinely chopped or cut with a sharp knife.

In use, a user holds a cutting implement such as a knife or cleaver in the other hand, placing the knife shaft inside the guide slot. The user places his fingers with the attached device on top of the work piece and while feeding the work piece into the knife with the thumb of the hand holding the work piece, and guiding the work piece in the same direction with the index and middle finger with the fingers slightly bent toward the thumb of the same hand, utilizes a quick and somewhat forceful chopping motion with the hand holding the cutting implement.

The knife guide and finger protection device is attached to either the index and middle fingers, or just to the middle finger of the user's hand that would normally hold an object for cutting with an implement such as a knife held in the opposite hand. The knife guide is designed in such a way as to cause the user to hold the work piece in a proper manner to provide protection. Additionally, the invention holds the cutting implement captive inside a guide slot so as to only allow the knife to move in a controlled up and down fashion, without the ability to come in contact with any part of the user's hand or fingers.

The knife guide and finger protection device disclosed has two main components. The first is the knife guide which guides the cutting implement while keeping it in a safe proximity to the user's hand which holds the work piece. And the finger attachment device which is affixed to the guide thus providing a safe and secure attachment to the user's hand or fingers. This attachment device will envelope a portion of the user's index and/or middle finger snuggly and securely so as to prevent the guide from having motion independent from the hand it is attached to.

The knife guide and finger protection device is structured as a framework made from bending stiff steel wire, or bending and cutting thin gauge sheet metal. In both cases molded plastic may be used to form a guide slot to accommodate a cutting implement in such a way as to guide it's up and down motion and prevent lateral motion. Rubber, elastic, metal or some other suitable material may be used to attach the guide device to the user's hand or finger . . . . The components are assembled using any method or combination of methods such as electro mechanical welding, adhesives, chemical bonding, adhesives, fasteners, rivets, bolts and nuts, epoxies, etc.

The knife guide and finger protection device disclosed is not limited to the uses described above, but is beneficial to the novice home cook who wishes to quickly chop produce in a manner displayed by professionals. The invention is likewise beneficial for culinary students learning to cut and chop produce for the first time and food service personnel who might otherwise be prone to workplace cutting injury. In addition, a level of independence is provided to people who are afflicted with illness, disease or injury that would otherwise prevent them from safely utilizing a cutting utensil for the purpose of cutting or chopping produce by hand.

Referring to FIG. 1, there is shown a perspective view of a knife guide and finger protection device 10 in accordance with the principles of the invention. The guide may be made of a stiff wire, plastic, stainless steel or steel which is stamped out of a flat sheet and bent to shape, etc. Looking at the front of the knife guide, it is bent to provide a first U shaped member 12. The top ends of the U shaped members are bent downward with 180 degree bends to locate two rails 14 which are parallel to the arms of the U shaped member and which form two side slots 16, one on each side of the U shaped member which are open at the bottom for receiving and guiding a knife blade as it is moved up and down in the slots. The bottom arms of the U shaped member 12 are connected with a cross member 18 and the bottom ends of the rails 14 are bent upwards and connected at their tops with a cross member to form an inverted second U shaped member 20. Additional ladder shaped support members are attached to U shaped member 20. The space between the second U shaped member and the rails forms a slot 22 which is open at the top for receiving a finger protection device. The top cross piece of the second U shaped member may be padded with a strip of rubber, plastic, etc which can form a friction fit with a finger protection guide which is placed over the second U shaped member.

Thus, the knife guide and finger protection device has a first right side up U shaped member 12 located next to vertical rails 14 which have no top or bottom cross members, and a second inverted U shaped member 20 which is located next to the vertical rails. The space between the first U shaped member and the vertical rails forms two spaced apart slots or channels 16 which are open at the bottom for receiving and guiding a knife blade as it is moved up and down. The space between the vertical rails and the second inverted U shaped member 20 is for receiving the finger protection guide which is placed over the third U shaped member.

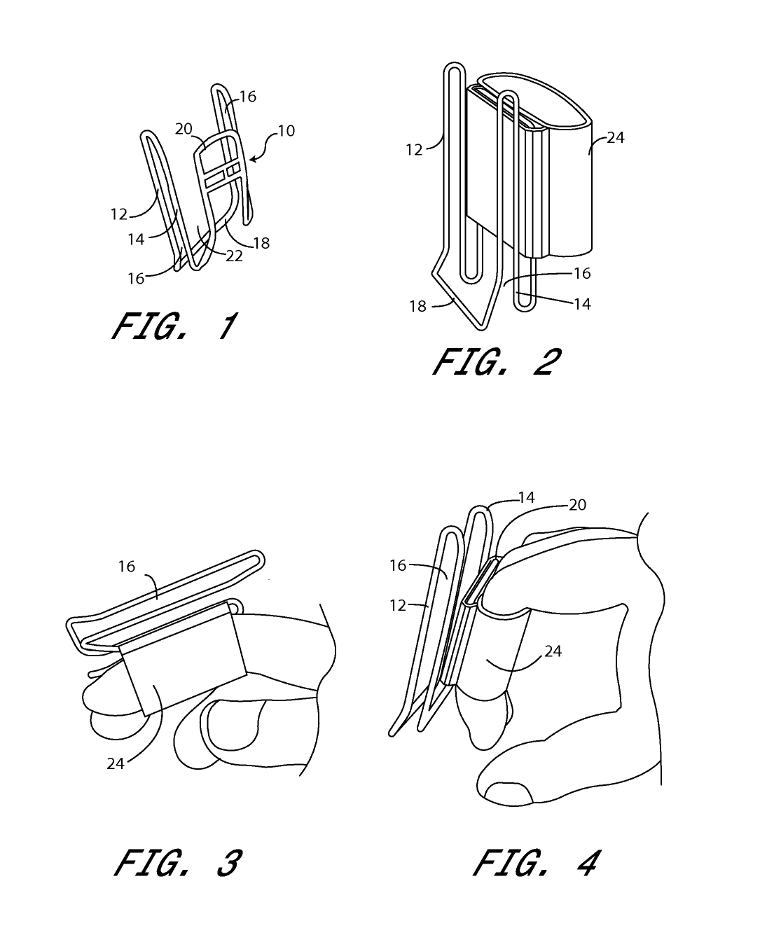

Referring to FIG. 2, there is shown a perspective view of the knife guide and finger protection device of FIG. 1 with the finger protection device 24 fitted over the third U shaped member.

Referring to FIG. 3, there is shown a perspective view of the knife guide and finger protection device of FIG. 1 with the finger protection device 24 attached to the second U shaped member and where a user's two fingers are located in the finger protection device. The finger protection device may be made of a soft plastic, cloth, fabric, rubber, leather etc, and includes a first narrow compartment for receiving the second U shaped member and a second larger compartment for receiving one or two fingers of a user of the knife guide and finger protection device.

Referring to FIG. 4, there is shown another perspective view of the knife guide and finger protection device of FIG. 1 with a users two fingers located in the finger protection device.

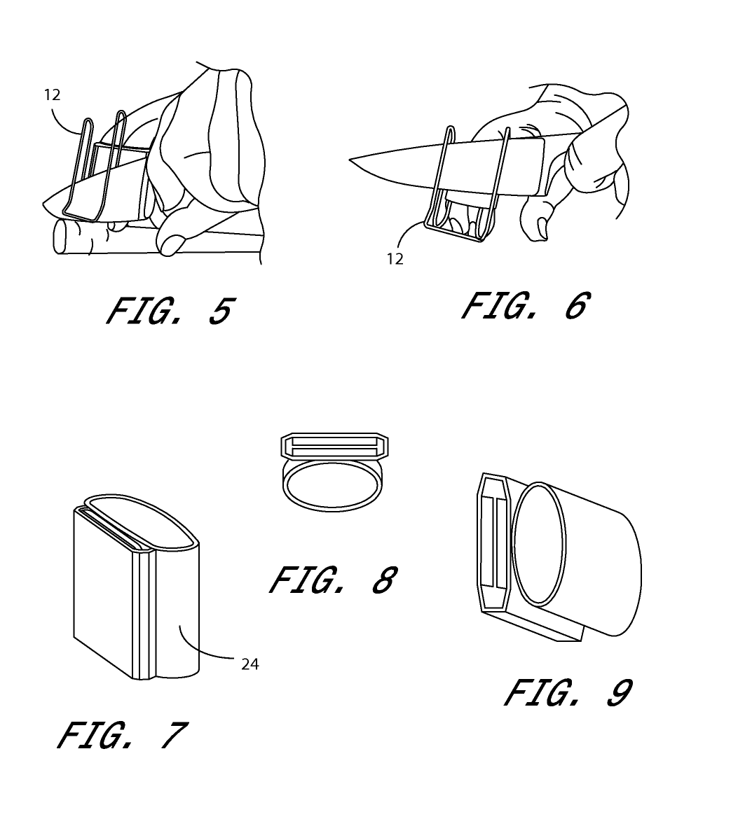

Referring to FIG. 5, there is shown a perspective view of the knife guide and finger protection device of FIG. 1 where the user is moving the knife blade down to cut a work piece such as a carrot.

Referring to FIG. 6, there is shown a perspective view of the knife guide and finger protection device of FIG. 5 with the knife and finger attachment attached to the user's two fingers.

Referring to FIG. 7, there is shown a perspective view of the finger protection device.

Referring to FIG. 8, there is shown a cross sectional view of the finger protection device of FIG. 7.

Referring to FIG. 9, there is shown a side perspective view of the finger protection device of FIG. 7.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. Apparatus for guiding a knife blade as it moves up and down while cutting or chopping a food item comprising:
a first U shaped member having two vertical arms and a cross member which is located at and is attached to the bottom ends of the two arms;
two rails each having a top end attached to the top end of the first U shaped member and a bottom end wherein the two rails are located behind the two vertical arms of the first U shaped member; and
a second inverted U shaped member having two vertical arms and a cross member which is located at and is attached to the top ends of the two arms wherein the two vertical arms are located behind and attached to the bottom ends of the two rails;
wherein the space between the two vertical arms of the first U shaped member and the two rails located behind the two vertical arms of the first U shaped member form two spaced apart slots for guiding a knife blade as it is moved up and down while cutting or chopping a food item.

2. The apparatus of claim 1 wherein a finger protection device having a first compartment adapted to be removably attached to the second U shaped member and a second compartment for receiving at least one finger of a person using the apparatus.

3. The apparatus of claim 2 wherein the second compartment is sized to receive two fingers of a person using the apparatus.

4. The apparatus of claim 3 wherein the second compartment is sized to receive the index and middle fingers of a person using the apparatus.

5. The apparatus of claim 4 wherein the second compartment is a sleeve that is open at the top and bottom.

6. The apparatus of claim 5 wherein the first compartment is a sleeve which is open at the top and bottom.

7. The apparatus of claim 5 wherein the first compartment is a sleeve which is closed at the top and open at the bottom.

8. The apparatus of claim 1 wherein the first and second U shaped members and the two rails are made of stiff wire of steel or stainless steel.

9. The apparatus of claim 1 wherein the first and second U shaped members and the two rails are stamped out of a sheet of metal which is then bent to shape.

10. The apparatus of claim 2 wherein the finger protection device is made of plastic, cloth or fabric.

11. A method for guiding a knife blade as it moves up and down while cutting or chopping a food item comprises:
providing a first U shaped member having two vertical arms and a cross member which is located at and is attached to the bottom ends of the two arms;
providing two rails each having a top end attached to the top end of the first U shaped member and a bottom end wherein the two rails are located behind the two vertical arms of the first U shaped member; and
providing a second inverted U shaped member having two vertical arms and a cross member which is located at and is attached to the top ends of the two arms wherein the two vertical arms are located behind and attached to the bottom ends of the two rails;
wherein the space between the two vertical arms of the first U shaped member and the two rails located behind the two vertical arms of the first U shaped member form two spaced apart slots for guiding a knife blade as it is moved up and down while cutting or chopping a food item.

12. The method of claim 11 wherein a finger protection device having a first compartment adapted to be removably attached to the second U shaped member and a second compartment for receiving at least one finger of a person using the apparatus.

13. The method of claim 12 wherein the second compartment is sized to receive two fingers of a person using the apparatus.

14. The method of claim 13 wherein the second compartment is sized to receive the index and middle fingers of a person using the apparatus.

15. The method of claim 14 wherein the second compartment is a sleeve that is open at the top and bottom.

16. The method of claim 15 wherein the first compartment is a sleeve which is open at the top and bottom.

17. The method of claim 15 wherein the first compartment is a sleeve which is closed at the top and open at the bottom.

18. The method of claim 11 wherein the first and second U shaped members and the two rails are made of stiff wire of steel or stainless steel.

19. The method of claim 11 wherein the first and second U shaped members and the two rails are stamped out of a sheet of metal which is then bent to shape.

20. The method of claim 12 wherein the finger protection device is made of plastic, cloth or fabric.
